(19) United States
(12) Patent Application Publication
(10) Pub. No.: US 2010/0177284 A1
(43) Pub. Date: Jul. 15, 2010

(54) Projector Display Device

(75) Inventors: Frank J. Moizio, Dallas, TX (US); Julius G. Horvath, Plano, TX (US); Jeffrey A. Garrett, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/354,485

(22) Filed: Jan. 15, 2009

(51) Int. Cl. G03B 21/10; G03B 21/28

(52) U.S. Cl. 353/75; 353/121; 353/77

(57) ABSTRACT

According to one embodiment, a projector display device includes an enclosure configured with a projection hole and a translucent display screen configured over an aperture in the enclosure. The projection hole receives a light beam generated by a projector. The light beam is directed toward the translucent display screen for producing imagery on the translucent display screen.

### TECHNICAL FIELD OF THE DISCLOSURE

This disclosure generally relates to display devices, and more particularly, to a projector display device that displays imagery generated by projectors.

### BACKGROUND OF THE DISCLOSURE

Handheld projectors, which may also be referred to as pocket projectors, are relatively small devices that generate imagery from various image sources, such as television tuners, personal computers, digital video disk (DVD) players, and video cassette recorders (VCRs). Images are produced by projecting a beam of light onto an external surface, such as, for example, a projection screen, or any generally flat wall. These handheld projectors overcome drawbacks of other portable electronic devices, such as personal digital assistants, wireless telephones, or digital cameras having displays with viewing sizes that are limited to the size of their housings.

### SUMMARY OF THE DISCLOSURE

According to one embodiment, a projector display device includes an enclosure configured with a projection hole and a translucent display screen configured over an aperture in the enclosure. The projection hole receives a light beam generated by a projector. The light beam is directed toward the translucent display screen for producing imagery on the translucent display screen.

Some embodiments of the disclosure may provide numerous technical advantages. For example, one embodiment of the projector display device may provide enhanced view of imagery in bright light conditions, such as during sunlight conditions. In many cases, ambient sunlight may generate greater ambient light than desirable for display by projectors, such as handheld projectors. The enclosure blocks ambient light to alleviate interference that may hinder view of imagery produced by the handheld projectors.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a perspective view of one embodiment of a projector display device according to the teachings of the present disclosure;

FIG. 2 is a side view of the projector display device of FIG. 1 shown with one side panel removed to reveal a mirror disposed within the enclosure that may be used to reflect the light beam projected by the projector;

FIG. 3A is a perspective view of the projector display device of FIG. 1 showing an intermediary configuration; and

FIG. 3B is a perspective view of the projector display device of FIG. 1 showing its collapsed configuration having an essentially flat shape.

### DETAILED DESCRIPTION OF EXAMPLE EMBODIMENTS

Handheld projectors generate imagery using a light beam that is externally projected onto any generally flat surface. These devices overcome a distinct disadvantage of other electronic portable viewing devices in that the size of the resulting image is not limited to the dimensional constraints of its housing. Due to the relatively portable nature of handheld devices, imagery may be viewed at virtually any location desired by its user. Bright ambient conditions, however, may cause difficulty in viewing imagery with these devices. For example, view of imagery using a handheld device outdoors on a bright sunny day may be difficult due to direct and reflected sun rays that may be greater in luminous intensity than the light beam generated by the handheld device.

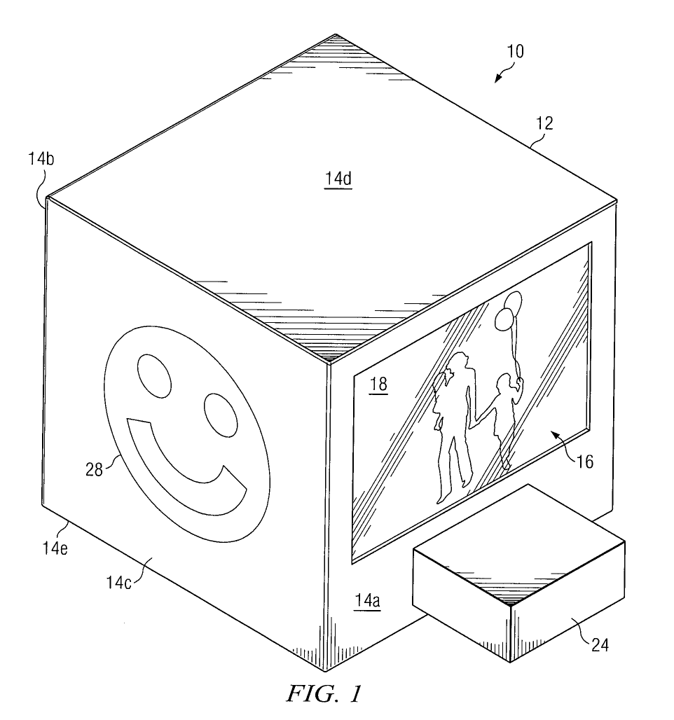

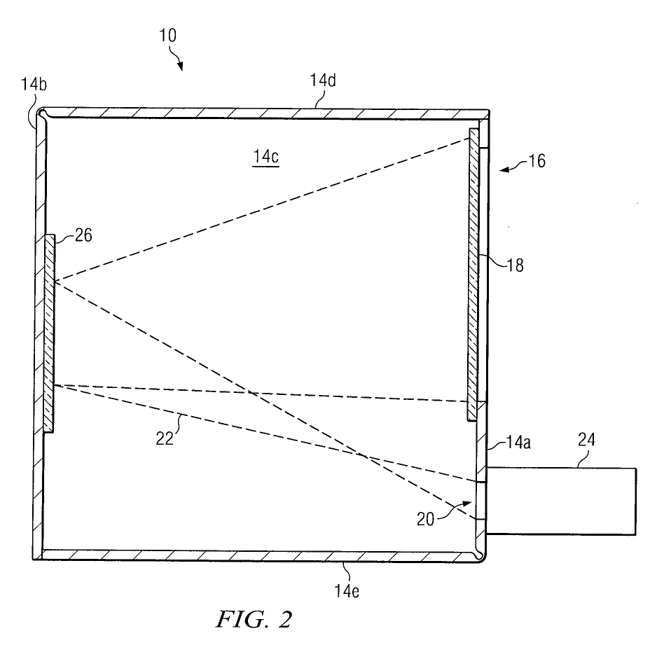

FIGS. 1 and 2 show one embodiment of a projector display device 10 that may provide a solution to this problem and other problems. Projector display device 10 includes an enclosure 12 having a front panel 14a, a rear panel 14b, two side panels 14c, a top panel 14d, and a bottom panel 14e. Enclosure 12 has an aperture 16 that is configured with a display screen 18 and a projection hole 20 (FIG. 2) configured on its front panel 14a. Projection hole 20 receives a light beam 22 generated by a projector 24. Projector display device 10 includes a mirror 26 for reflecting light beam 22 towards display screen 18. Display screen 18 is translucent in opacity and thus operable to display imagery generated by projector 24 for view outside of enclosure 12. Projector 24 may be a handheld projector, wireless telephone, or any other electronic device that generates a light beam for producing imagery externally from its own housing.

Certain embodiments of projector display device 10 provides view of imagery in relatively brighter ambient conditions than may be provided by projector 24 when used alone. Panels 14 of enclosure 12 block ambient light from interfering with the various elements of projector display device 10, such as mirror 26 and display screen 18, that manipulate light beam 22 into a viewable image. Thus in some embodiments, projector display device 10 may provide use of projector 24 in ambient lighting conditions that may be too bright for projector 24 when used without projector display device 10.

Enclosure 12 may be made of any suitable type of material, such as paperboard, fiberboard, poster board, wood, plastic, or card stock, that is opaque to light and generally rigid such that enclosure 12 maintains its predetermined shape during normal use. In the particular embodiment shown, enclosure 12 is made of a sheet of card stock that is bent to form a cube shape having a height, a length, and a width of approximately 12 inches each. This size of enclosure 12 provides display screen 18 with a viewing size of approximately 15 inches. In other embodiments, enclosure 12 may have any shape or size, such as a wedge, semi-circular, cuboid, or other shape having at least one generally flat surface for implementation of display screen 18 and may have any desired dimensions. Enclosure 12 may include one or more forms of indicia 28 on its outer surface. Indicia 28 may include patterns, logos, photographs, and/or illustrations suitable for any purpose, such as promotional advertisements or enhancing the look and feel of projector display device 10.

In one embodiment, projector display device 10 may include a docking receptacle (not shown) for maintaining the projector at a fixed position relative to enclosure 12. In one embodiment, docking receptacle may include tabs formed in front panel 14a proximate projection hole 20 that may be bent outwardly from enclosure 12 for holding projector 24 using a friction fit. In another embodiment, docking receptacle may include slots or other similar type of aperture formed in front panel 14a for engagement of protrusions or other physical features configured on projector 24.

Display screen 18 and mirror 26 may each be made of any suitable type of material that refracts or reflects light beam 22, respectively, in a suitable manner. Display screen 18 is attached to enclosure along the periphery of display aperture 16 using a suitable adhesive. Likewise, mirror 26 may be attached to rear panel 14 of enclosure 12 using a suitable adhesive. Mirror 26 is included in the particular embodiment for reflecting light beam 22 from projection hole 20 to display screen 18. Other embodiments of projector display device 10, however, may include no mirrors or multiple mirrors that reflect light beam 22 multiple times along its path from projector 24 to display screen 18.

Use of one or more mirrors 26 with projector display device 10 may tailor projector display device 10 for use with differing projectors 24 having varying throw ratios. A term “throw ratio” generally refers to the projected image size as a factor of its distance from the projector. Stated another way, the throw ratio of a projector generally describes the angular expansion of light beam 22 as it progresses away from projector 24 toward display screen 18. Implementation of one or more mirrors 26 with projector display device 10 may provide increased length from projector 24 to display screen 18 for enlarging the resulting image displayed by display screen 18.

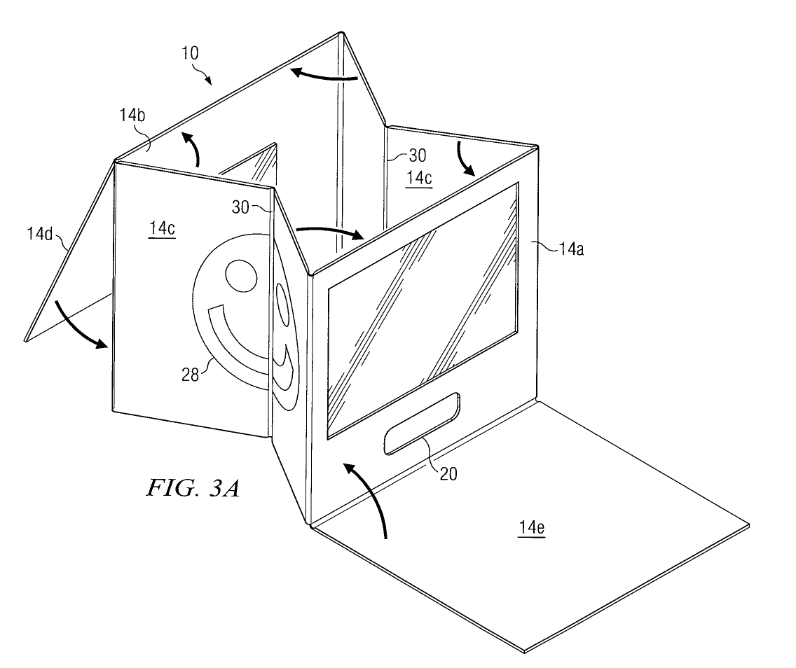

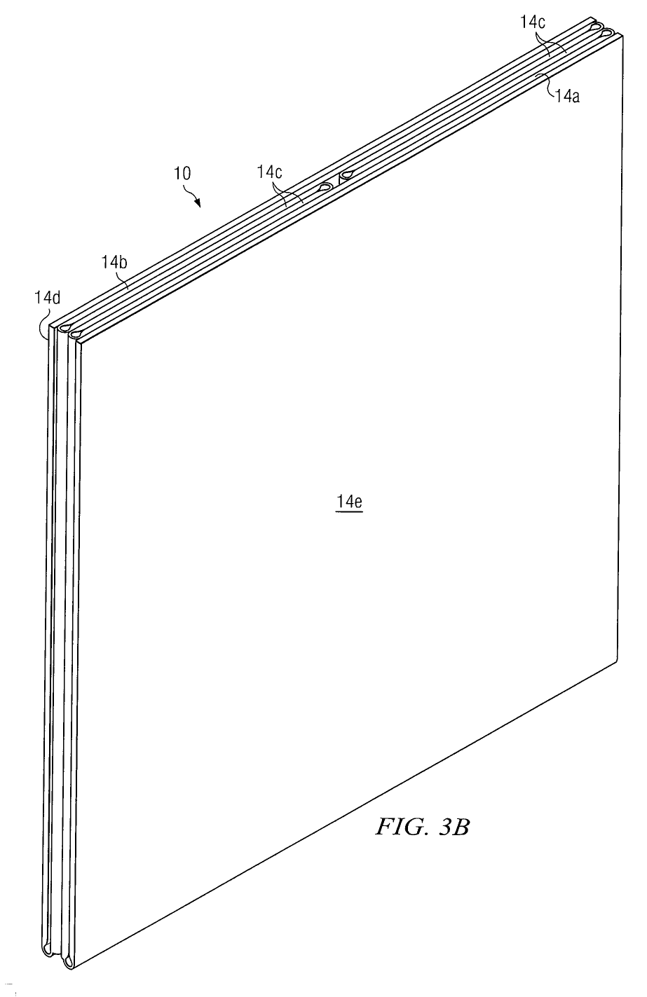

FIGS. 3A and 3B show a process of collapsing enclosure 12 into a generally flat shape when not in use. FIG. 3B shows an intermediary configuration of enclosure 12 in which enclosure 12 is partially collapsed into a flat shape as shown in FIG. 3B. Certain embodiments of enclosure 12 having a flat shape as shown in FIG. 3B may enhance its portability by occupying a relatively smaller volume than when in the operative configuration as shown in FIG. 1.

To collapse enclosure 12, fold lines 30 are provided along side panels 14c that may be bent inwardly to move front panel 14a and rear panel 14b toward one another. Bottom panel 14e, which is hingedly coupled to the bottom edge of front panel 14a, is bent upwardly to lie adjacent front panel 14a, and top panel 14d, which is hingedly coupled to the top edge of rear panel 14b is bent downwardly to lie adjacent rear panel 14b. When movement of each of the panels 14 as previously described are completed, enclosure 12 has a collapsed configuration as shown in FIG. 3B. To configure enclosure 12 from the collapsed configuration (FIG. 3B) to the operative configuration (FIG. 1), the previously described process may be reversed.

Modifications, additions, or omissions may be made to projector display device 10 without departing from the scope of the disclosure. The components of projector display device 10 may be integrated or separated. For example, projector display device 10 may be provided with one or more mirrors 26 that are selectively positioned within enclosure 12 by the user for operation of projector display device 10 with differing types of projectors. Moreover, the operations of projector display device 10 may be performed by more, fewer, or other components. For example, optical filters may be disposed inside enclosure 12 and positioned in the path of light beam 22 for manipulating the optical characteristics of imagery displayed by projector display device 10. As used in this document, “each” refers to each member of a set or each member of a subset of a set.

Although the present disclosure has been described with several embodiments, a myriad of changes, variations, alterations, transformations, and modifications may be suggested to one skilled in the art, and it is intended that the present disclosure encompass such changes, variations, alterations, transformation, and modifications as they fall within the scope of the appended claims.

What is claimed is:

1. A projector display device comprising:
an enclosure having a cube shape that is operable to be collapsed to an essentially flat shape, the enclosure comprising:
a display aperture configured over a portion of an outer surface of the enclosure, the display aperture covered by a translucent display screen that is attached to the enclosure and extending across the display aperture;
a projection hole configured in the enclosure that is operable to receive a light beam from a projector; and
a mirror disposed over a portion of an inside surface of the enclosure, the mirror operable to reflect the light beam toward the translucent display screen for generating an image on the translucent display screen.

2. The projector display device of claim 1, wherein the projector is coupled to the enclosure adjacent the projection hole.

3. A projector display device comprising:
an enclosure comprising:
a display aperture configured over a portion of an outer surface of the enclosure, the display aperture covered by a translucent display screen that is attached to the enclosure and extending across the display aperture; and
a projection hole configured in the enclosure that is operable to receive a light beam from a projector, the light beam generating an image on the translucent display screen.

4. The projector display device of claim 3, wherein the projector is a handheld projector.

5. The projector display device of claim 3, wherein the enclosure further comprises at least one mirror disposed inside the enclosure that is operable to reflect the light beam from the projector to the translucent display screen.

6. The projector display device of claim 3, wherein the at least one mirror is formed over a portion of an inside surface of the enclosure.

7. The projector display device of claim 3, wherein the enclosure has a cube shape.

8. The projector display device of claim 7, wherein the enclosure is operable to be collapsed to an essentially flat shape.

9. The projector display device of claim 3, wherein the enclosure is formed of press board.

10. The projector display device of claim 3, wherein another portion of the outer surface of the enclosure comprises indicia that is selected from the group consisting of advertising indicia, patterns, logos, photographs, and illustrations.

11. The projector display device of claim 3, further comprising a docking receptacle coupled to the enclosure and operable to maintain the projector at a fixed position relative to the enclosure.

12. A method for displaying imagery comprising:
providing an enclosure comprising a display aperture and a projection hole, the display aperture configured over a portion of an outer surface of the enclosure, the display aperture covered by a translucent display screen that is attached to the enclosure and extending over the display aperture; and
forming an image on the translucent display screen by generating a light beam through the projection hole using a projector.

13. The method of claim 12, further comprising disposing the projector adjacent to an outer surface of the enclosure.

14. The method of claim 13, further comprising coupling the projector to a docking receptacle disposed proximate the projection hole.

15. The method of claim 12, further comprising collapsing the enclosure to an essentially flat shape.

16. The method of claim 15, further comprising directing the light beam towards a mirror disposed inside the enclosure, the mirror reflecting the light beam towards the translucent display screen.
